(19) United States
(12) Patent Application Publication
(10) Pub. No.: US 2007/0216299 A1
(43) Pub. Date: Sep. 20, 2007

(54) DISPLAY DEVICE AND METHOD OF MANUFACTURING THE SAME

(75) Inventors: Kyong-Tae PARK, Uijeongbu-si (KR); Chun-Seok KO, Hwaseong-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD.,, Suwon-si (KR)

(21) Appl. No.: 11/688,342

(22) Filed: Mar. 20, 2007

(30) Foreign Application Priority Data
Mar. 20, 2006 (KR) 1020060025172

(51) Int. Cl. H01J 1/62

(52) U.S. Cl. 313/512

(57) ABSTRACT

A display device includes a display panel including a plurality of pixels, a printed circuit board driving the display panel, a flexible printed circuit and a driving package. The flexible printed circuit includes an input unit attached to a top surface of the printed circuit board and an output unit attached to the display panel. The driving package includes an input unit attached to the top surface of the printed circuit board and an output unit attached to the display panel. A length from a central portion of the driving package to the input unit of the driving package is larger than a length from a central portion of the flexible printed circuit to the input unit of the flexible printed circuit.

This application claims priority to Korean Patent Application No. 10-2006-0025172 filed on Mar. 20, 2006, and all the benefits accruing therefrom under 35 U.S.C. § 119, the contents of which in its entirety are herein incorporated by reference.

### BACKGROUND OF THE INVENTION

(a) Field of the Invention

The present invention relates to a display device and a method of manufacturing the same. More particularly, the present invention relates to an organic light emitting diode (“OLED”) display and a method of manufacturing the same.

(b) Description of the Related Art

As personal computers and televisions have become lighter in weight and smaller in size, lighter and smaller display devices are substituting conventional cathode ray tubes (“CRT”). The display devices include flat panel displays.

Examples of these flat panel displays may include a liquid crystal display (“LCD”), a field emission display (“FED”), an organic light emitting diode display, a plasma display panel (“PDP”), and the like.

In an active-matrix-type flat panel display, a plurality of pixels are disposed in a matrix, and images are displayed by controlling the optical strength of each pixel according to given luminance information. The organic light emitting diode display is a display device that electrically excites a fluorescent organic material to emit light so as to display images. Since the organic light emitting diode display is a self-luminous type and allows relatively lower power consumption, a wider viewing angle, and a more rapid response speed of a pixel, it may be relatively easier to display higher-quality moving pictures.

The organic light emitting diode display includes organic light emitting diodes (“OLEDs”) and thin film transistors (“TFTs”) that drive the organic light emitting diodes. The thin film transistors are classified into polysilicon thin film transistors, amorphous silicon thin film transistors, and so on, according to the type of active layers used.

As the size of the organic light emitting diode display increases, the amount of current consumed in displaying images with a comparable brightness increases. Therefore, the amount of current that needs to be supplied has become an important factor in determining display uniformity.

The organic light emitting diode display receives various signals from a printed circuit board through flexible printed circuits and driving packages in order to be driven. Accordingly, the flexible printed circuits and the driving packages are connected between the display panel and the printed circuit board of the organic light emitting diode display. However, the flexible printed circuits and the driving packages transmit different signals and have different thicknesses. As a result, it may be difficult for the flexible printed circuits and the driving packages to be attached to the display panel or the printed circuit board by a same process.

### BRIEF SUMMARY OF THE INVENTION

An exemplary embodiment provides an organic light emitting diode display having advantages of improving completeness of attachment in a process of attaching a driving package and a flexible printed circuit.

In an exemplary embodiment, there is provided a display device including a display panel that includes a plurality of pixels, a printed circuit board that drives the display panel, at least one flexible printed circuit film and at least one driving package. The at least one flexible printed circuit film includes an input unit attached to a top surface of the printed circuit board and an output unit attached to a top surface of the display panel. The at least one driving package includes an input unit attached to the top surface of the printed circuit board and an output unit attached to the top surface of the display panel. A length from a central portion of the driving package to the input unit of the driving package is larger than a length from a central portion of the flexible printed circuit to the input unit of the flexible printed circuit. The lengths from the central portions are taken in a longitudinal direction of the flexible printed circuit.

In an exemplary embodiment, a length from a central portion of the driving package to the output unit of the driving package may be larger than a length from a central portion of the flexible printed circuit to the output unit of the flexible printed circuit.

In an exemplary embodiment, an attaching region of the output unit of the flexible printed circuit and an attaching region of the output unit of the driving package may be on the same line in a longitudinal direction of the display panel.

In an exemplary embodiment, a distance Z between the driving package and the flexible printed circuit may satisfy the condition Z>X+Y (X indicates the length of an edge of a driving package attaching region, and Y indicates the length of an edge of a flexible printed circuit attaching region). The distance and the lengths of the edges are taken in a transverse direction of the flexible printed circuit.

In an exemplary embodiment, the flexible printed circuit may transmit a common voltage.

In an exemplary embodiment, the flexible printed circuit may transmit a driving voltage.

In an exemplary embodiment, the driving package may include a scanning driving integrated circuit.

In an exemplary embodiment, the driving package may include a data driving integrated circuit.

An exemplary embodiment provides a method of manufacturing a display device. The method includes attaching an output unit of a driving package to a display panel, attaching an output unit of a flexible printed circuit to the display panel, attaching an input unit of the driving package to a printed circuit board and attaching an input unit of the flexible printed circuit to the printed circuit board. A length from a central portion of the driving package to the input unit of the driving package is larger than the length from a central portion of the flexible printed circuit to the input unit of the flexible printed circuit. The lengths from the central portions are taken in a longitudinal direction of the flexible printed circuit.

An exemplary embodiment provides a display device including a display panel that includes a plurality of pixels, a printed circuit board that drives the display panel, a flexible printed circuit and a driving package. The flexible printed circuit includes an input unit attached to a top surface of the printed circuit board and an output unit attached to a top surface of the display panel. The driving package includes an input unit attached to the top surface of the printed circuit board and an output unit attached to the top surface of the display panel. The input unit of the driving package is located closer to a central portion of the printed circuit board than the input unit of the flexible printed circuit.

### BRIEF DESCRIPTION OF THE DRAWINGS

FIG. 1 is a block diagram of an exemplary embodiment of an organic light emitting diode display according to the present invention.

FIG. 2 is an equivalent circuit diagram of an exemplary embodiment of a pixel of an organic light emitting diode display according to the present invention.

FIG. 3 is a cross-sectional view illustrating an exemplary embodiment of a driving transistor and an organic light emitting diode of one pixel of an organic light emitting diode display shown in FIG. 2.

FIG. 4 is a schematic diagram of an exemplary embodiment of an organic light emitting diode of an organic light emitting diode display according to the present invention.

FIG. 5 is a plan view illustrating an exemplary embodiment of an organic light emitting diode display according to the present invention.

FIG. 6 is a plan view illustrating an exemplary embodiment of a connection portion between a display panel and a printed circuit board in an organic light emitting diode display according to the present invention.

FIG. 7 is a cross-sectional view of an exemplary embodiment of an organic light emitting diode display according to the present invention shown in FIG. 6 taken along line VII-VII.

FIG. 8 is a plan view illustrating another exemplary embodiment of a connection portion between a display panel and a printed circuit board in an organic light emitting diode display according to the present invention.

### DETAILED DESCRIPTION OF THE INVENTION

The present invention will be described more fully hereinafter with reference to the accompanying drawings, in which preferred embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art.

In the drawings, the thickness of layers, films, panels, and regions are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below”, “lower”, “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “lower” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

A display device and a method of driving the same according to exemplary embodiments of the present invention will be described in detail with reference to the accompanying drawings.

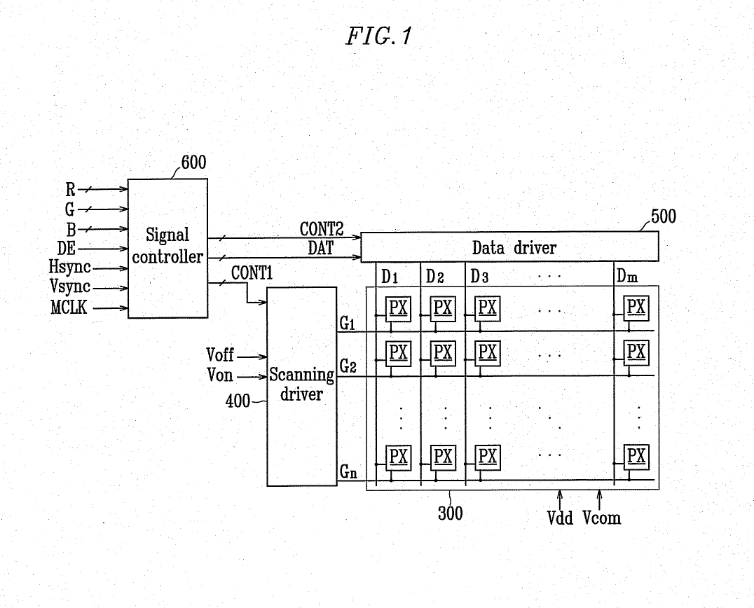

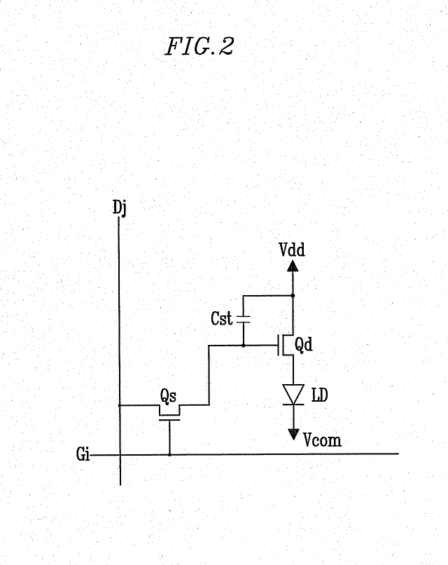

FIG. 1 is a block diagram of an exemplary embodiment of an organic light emitting diode display according to the present invention. FIG. 2 is an equivalent circuit diagram of an exemplary embodiment of one pixel of an organic light emitting diode display according to the present invention.

As shown in FIG. 1, an organic light emitting diode display includes a display panel 300, a scanning driver 400 and a data driver 500 that are connected to the display panel 300, and a signal controller 600 that controls the above-described elements.

As viewed in FIG. 1, the display panel 300 includes a plurality of display signal lines G₁ to Gₙ and D₁ to Dₘ, a plurality of driving voltage lines (not shown) and a plurality of pixels PX that are connected to the plurality of display signal lines and driving voltage lines disposed in a matrix.

The display signal lines G₁ to Gₙ and D₁ to Dₘ include a plurality of scanning signal lines G₁ to Gₙ that transmit scanning signals, and a plurality of data signal lines D₁ to Dₘ that transmit data signals. The scanning signal lines G₁ to Gₙ extend substantially in a row direction. The scanning signal lines G₁ to Gₙ are separated from one another and are substantially parallel to one another. The data signal lines D₁ to Dₘ extend substantially in a column direction. The data signal lines D₁ to Dₘ are separated from one another and are substantially parallel to one another.

The driving voltage line applies a driving voltage Vdd to each pixel PX.

As shown in FIG. 2, each pixel PX, such as a pixel PX that is connected to a scanning signal line Gᵢ and a data signal line Dⱼ, includes an organic light emitting diode LD, a driving transistor Qd, a capacitor Cst, and a switching transistor Qs.

The driving transistor Qd as a three-terminal element includes a control terminal that is connected to the switching transistor Qs and the capacitor Cst, an input terminal that is connected to a terminal of a driving voltage Vdd, and an output terminal that is connected to the organic light emitting diode LD.

The switching transistor Qs as a three-terminal element includes a control terminal that is connected to the scanning signal line Gᵢ, an input terminal that is connected to the data signal line Dⱼ, and an output terminal that is connected to the capacitor Cst and the driving transistor Qd.

The capacitor Cst is connected between the switching transistor Qs and the terminal of the driving voltage Vdd. The capacitor Cst charges a data voltage applied by the switching transistor Qs and maintains the data voltage for a predetermined time.

The organic light emitting diode LD may include an anode and a cathode that are connected to the driving transistor Qd and the terminal of the common voltage Vcom, respectively. The organic light emitting diode LD emits light with an intensity according to a current I_{LD} supplied by the driving transistor Qd, and displays images. The amount of current I_{LD} depends on a voltage Vgs between the control terminal and the output terminal of the driving transistor Qd.

In an exemplary embodiment, each of the switching transistor Qs and the driving transistor Qd may be composed of an n-channel field effect transistor (“FET”) that contains amorphous silicon or polysilicon. Alternatively, each of the switching transistor Qs and the driving transistor Qd may be composed of a p-channel field effect transistor. Since the p-channel field effect transistor FET and the n-channel field effect transistor are complementary in function to each other, the operation, voltage, and current of the p-channel field effect transistor FET are opposite to those of the n-channel field effect transistor FET.

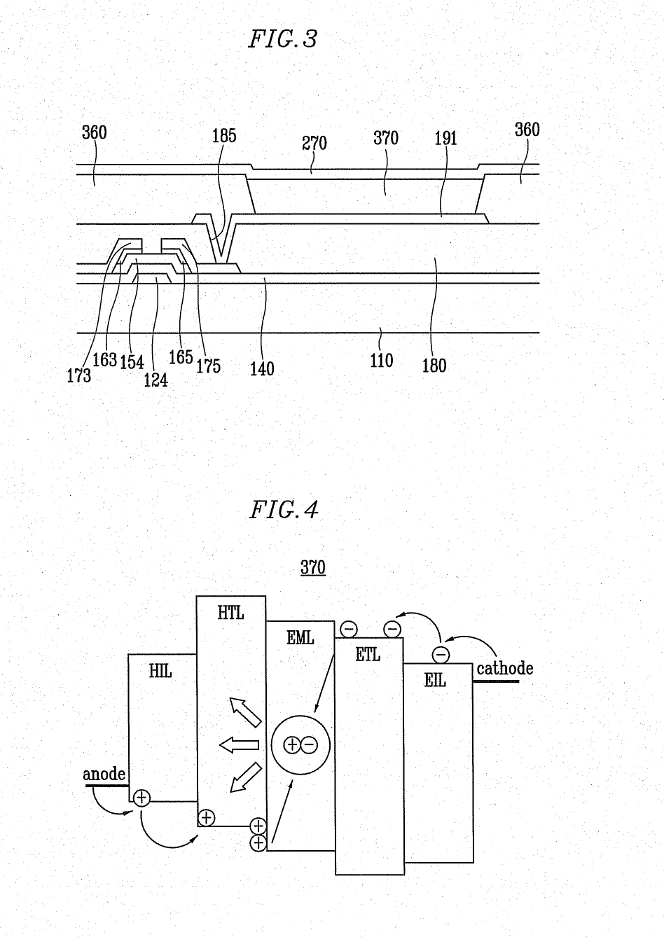

Hereinafter, exemplary embodiments of structures of the driving transistor Qd and the organic light emitting diode LD of the organic light emitting diode display shown in FIG. 2 will be described in detail with reference to FIGS. 3 and 4, respectively.

FIG. 3 is a cross-sectional view illustrating an exemplary embodiment of a driving transistor and an organic light emitting diode of one pixel of the organic light emitting diode display shown in FIG. 2. FIG. 4 is a schematic diagram illustrating an exemplary embodiment of an organic light emitting diode of an organic light emitting diode display according to the present invention.

A control terminal electrode 124 is formed on an insulating substrate 110. In an exemplary embodiment, the control terminal electrode 124 may be formed of an aluminum-based metal, such as aluminum (Al) and an aluminum alloy, a silver-based metal, such as silver (Ag) and a silver alloy, a copper-based metal, such as copper (Cu) and a copper alloy, a molybdenum-based metal such as molybdenum (Mo) and a molybdenum alloy, chromium (Cr), titanium (Ti), tantalum (Ta), and the like.

In an exemplary embodiment, the control terminal electrode 124 may have a multilayer structure including two conductive layers (not shown) with physical properties that are different from each other. One of the conductive layers may be made of a metal of relatively low resistivity to reduce signal delay or voltage drop. The metal of low resistivity may include, but is not limited to, an aluminum-based metal, a silver-based metal, a copper-based metal, and the like. The other of the two conductive layers may be made of a material of which physical, chemical, and electrical contact characteristics with indium tin oxide (“ITO”) and indium zinc oxide (“IZO”) are relatively good. The metal having good characteristics with indium tin oxide (“ITO”) and indium zinc oxide (“IZO”) may include, but is not limited to, a molybdenum-based metal, chromium, titanium, tantalum, and the like.

Exemplary embodiments of the control terminal electrode 124 may have a multilayer structure including two conductive layers may include a structure including a chromium lower layer and an aluminum (alloy) upper layer and a structure including an aluminum (alloy) lower layer and a molybdenum (alloy) upper layer. Alternatively, the control terminal electrode 124 can be made of any of an umber of various metals or conductors other than the above-described materials as is suitable for the purpose described herein.

Lateral sides of the control terminal electrode 124 may be inclined relative to an upper surface (e.g., substantially horizontal) of the substrate 110. An inclination angle of the lateral sides of the control terminal 124 may be in a range of about 30° to about 80°.

An insulating layer 140 is formed on the control terminal electrode 124. The insulating layer 140 may include silicon nitride (SiNₓ) or the like

A semiconductor 154 is formed on the insulating layer 140. The semiconductor 154 may include, but is not limited to, hydrogenated amorphous silicon (a-Si) or polycrystalline silicon

A pair of ohmic contacts 163 and 165 is formed on the semiconductor 154. The ohmic contacts may include materials such as n+ hydrogenated amorphous silicon that is doped with silicide or an n-type impurity at a high concentration.

Lateral sides of the semiconductor 154 and the ohmic contacts 163 and 165 are inclined relative to the upper and substantially horizontal surface of the substrate 110. Inclination angles of the lateral sides of the semiconductor 154 and the ohmic contacts 163 and 165 are in a range of about 30° to about 80°.

The input terminal electrode 173 and the output terminal electrode 175 are formed on the ohmic contacts 163 and 165, and on the insulating layer 140. In an exemplary embodiment the input terminal electrode 173 and the output terminal electrode 175 be made of refractory metals such as chromium, a molybdenum-based metal, tantalum, titanium, or the like.

The input terminal electrode 173 and the output terminal electrode 175 may have a multilayer structure including a lower layer (not shown) such as a refectory metal layer and an upper layer (not shown) having low resistance formed on the lower layer. Exemplary embodiments of the multilayer structure may include a dual-layer structure including a chromium or molybdenum (alloy) lower layer and an aluminum upper layer, and a triple-layer structure including a molybdenum (alloy) lower layer, an aluminum (alloy) intermediate layer, and a molybdenum (alloy) upper layer. The lateral sides of the input electrode 173 and the output terminal electrode 175 may be inclined relative to the upper surface of the substrate 110. Inclination angles of the lateral sides of the input electrode 173 and the output terminal electrode 175 may range from about 30° to about 80°.

The input terminal electrode 173 and the output terminal electrode 175 are separated from each other and are disposed opposite to each other relative to the control terminal electrode 124. The control terminal electrode 124, the input terminal electrode 173 the output terminal electrode 175 and the semiconductor 154 form the driving transistor Qd. A channel of the driving transistor Qd may be formed in the semiconductor 154 between the input terminal electrode 173 and the output terminal electrode 175.

The ohmic contacts 163 and 165 are only disposed between the semiconductor 154 located at the lower side, and the input terminal electrode 173 and the output terminal electrode 175 located at the upper side. The ohmic contacts 163 and 165 reduce contact resistance. A portion of the semiconductor 154 may not be covered by the input terminal electrode 173 or the output terminal electrode 175 as illustrated in FIG. 3.

A passivation layer 180 is formed on the input terminal electrode 173, the output terminal electrode 175, the exposed portion of the semiconductor 154 and the insulating layer 140. In an exemplary embodiment, the passivation layer 180 may be formed of an inorganic insulating material, such as silicon nitride (SiNx) or silicon oxide (SiO₂), an organic insulating material, or an insulating material having a relatively low dielectric constant. A dielectric constant of the insulating material having a low dielectric constant may be 4.0 or less. The insulating material having a low dielectric constant may include, but is not limited to, a-Si:C:O, a-Si:O:F, or the like. In an exemplary embodiment, the passivation layer 180, such as including the insulating material having a low dielectric constant may be formed by plasma enhanced chemical vapor deposition (“PECVD”). The passivation layer 180 may include the organic insulating material having photosensitivity.

An upper surface of the passivation layer 180 may be substantially flat as illustrated in FIG. 3. The passivation layer 180 may have a dual-layer structure (not shown) including a lower inorganic layer and an upper inorganic layer to reduce or effectively prevent damage to the exposed portion of the semiconductor 154, while preserving relatively good insulating characteristics of an organic film. A contact hole 185 for exposing the output terminal electrode 175 is formed in the passivation layer 180.

A pixel electrode 191 is formed on the passivation layer 180. The pixel electrode 191 is physically and electrically connected to the output terminal electrode 175 through the contact hole 185. The pixel electrode 191 may be formed of a transparent conductive material, such as ITO or IZO, or a metal such as an aluminum or silver alloy, which has relatively good reflectivity.

A partition 360 is formed on the passivation layer 180. The partition 360 surrounds a peripheral region of the pixel electrode 191 forming a “bank” on the pixel electrode 191 and thereby defining an opening. In an exemplary embodiment, the partition 360 may be formed of an organic insulating material or an inorganic insulating material.

An organic light emitting member 370 is formed on the pixel electrode 191. As illustrated in FIG. 3, the organic light emitting member 370 may be disposed in the opening surrounded by the partitions 360.

As shown in FIG. 4, the organic light emitting member 370 includes a multilayered structure that includes a light emitting layer (“EML”) and auxiliary layers for improving the light emitting efficiency of the light emitting layer (“EML”). The auxiliary layers include an electron transport layer (“ETL”) and a hole transport layer (“HTL”) that balance the number of electrons and the number of holes, and an electron injecting layer (“EIL”) and a hole injecting layer (“HIL”) that enhance injection of the holes and the electrons. In alternative exemplary embodiments, the auxiliary layers may be omitted.

Referring again to FIG. 3, on the partition 360 and the organic light emitting member 370, a common electrode 270 applied with a common voltage (“Vcom”) is formed. In exemplary embodiments, the common electrode 270 may be formed of a reflective metal that contains a material, such as calcium (Ca), barium (Ba), aluminum (Al), silver (Ag), or the like, or a transparent conductive material such as ITO or IZO.

In an exemplary embodiment, a non-transparent pixel electrode 191 and a transparent common electrode 270 may be applied to a top emission type of organic light emitting diode display that displays images above the display panel 300. In an alternative embodiment, a transparent pixel electrode 191 and a non-transparent common electrode 270 may be applied to a bottom emission type of organic light emitting diode display that displays images below the display panel 300.

The pixel electrode 191, the organic light emitting member 370 and the common electrode 270 form the organic light emitting diode shown in FIG. 2. The pixel electrode 191 becomes an anode and the common electrode 270 becomes a cathode. In an alternative embodiment, the pixel electrode 191 may become the cathode while the common electrode 270 becomes the anode. The organic light emitting diode (“LD”) emits light of one color of primary colors according to a material of the organic light emitting member 370. The primary colors may include, but are not limited to, three primary colors such as red, green, and blue (R, G and B). Desired images are displayed by a spatial sum of light of the three primary colors.

Referring back to FIG. 1, the scanning driver 400 may be connected to the scanning signal lines G₁ to Gₙ, and may apply a scanning signal including a combination of a high voltage Von that is capable of turning on a switching transistor Qs, and a low voltage Voff that is capable of turning off the switching transistor Qs to the scanning signal lines G₁ to Gₙ.

The data driver 500 may be connected to the data signal lines D₁ to Dₘ, and may apply a data voltage to the data signal lines D₁ to Dₘ.

The signal controller 600 controls operations of the scanning driver 400 and the data driver 500, and corrects input image data R, G, and B.

The scanning driver 400 and/or the data driver 500 may be directly mounted on the display panel 300, as may be at least one driving IC chip, or may be mounted on a flexible printed circuit film (not shown) and attached to the display panel 300 as a TCP (Tape Carrier Package). Alternatively, the scanning driver 400 and/or the data driver 500 may be integrated into the display panel 300. The data driver 500 and/or the signal controller 600 may be integrated into a single IC chip. As used herein, “integrated” is used to indicate formed to be a single unit or piece rather than combining separate elements.

From an exterior graphics controller (not shown), the signal controller 600 receives input image data R, G, and B and input control signals for controlling the display of the input image data R, G, and B. Input control signals may include, but are not limited to, a vertical synchronization signal (“Vsync”), a horizontal synchronization signal (“Hsync”), a main clock signal (“MCLK”), a data enable signal (“DE”), or the like. On the basis of the input image data R, G, and B and the input control signals, the signal controller 600 corrects the input image data R, G, and B to create output image data DAT, creates a scanning control signal CONT1 and data control signal CONT2. The signal controller 600 outputs the scanning control signal CONT1 to the scanning driver 400, and outputs the data control signal CONT2 and the output image data DAT to the data driver 500.

The scanning control signal CONT1 may include a scanning synchronization start signal STV instructing to start scanning of the high voltage Von, and at least one clock signal that controls the output of the high voltage Von.

The data control signal CONT2 may include a horizontal synchronization start signal STH for informing a transmission start of the image data relative to one row of pixels, a load signal LOAD instructing to apply the data voltage to the data signal lines D₁ to Dₘ, and a data clock signal HCLK.

The data driver 500 sequentially receives the image data DAT for one row of pixels according to the data control signal CONT2 from the signal controller 600, and converts the respective image data DAT into a data voltage to apply the voltage to the corresponding data signal lines D₁ to Dₘ.

The scanning driver 400 applies the scanning signals to the scanning signal lines G₁ to Gₙ according to the scanning control signal CONT1 from the signal controller 600, thereby turning on the switching transistors Qs connected to the scanning signal lines G₁ to Gₙ. The data voltage applied to the data signal lines D₁ to Dₘ is applied to the control terminals of the corresponding driving transistors Qd through the switching transistors Qs that have been turned on.

The data voltage applied to the driving transistor Qd is charged in a capacitor Cst. Even though the switching transistor Qs may be turned off, the charged data voltage is maintained. When the data voltage is applied, the driving transistor Qd is turned on, and outputs a current I_{LD} depending on the data voltage. In addition, the current I_{LD} flows through the organic light emitting diode LD, and the corresponding pixel PX displays images.

After one horizontal period (“1H”) (e.g., one period of a horizontal synchronization signal (“Hsync”) and a data enable signal (“DE”)), the data driver 500 and the scanning driver 400 repeat the same operation for pixels PX of a next row. In this way, in one frame, a scanning signal is sequentially applied to all scanning signal lines G₁ to Gₙ and a data voltage is applied to all pixels PX. When one frame is completed, a next frame starts, and the same operation is repeated during the next frame.

Hereinafter, exemplary embodiments of an organic light emitting diode display will be described in detail.

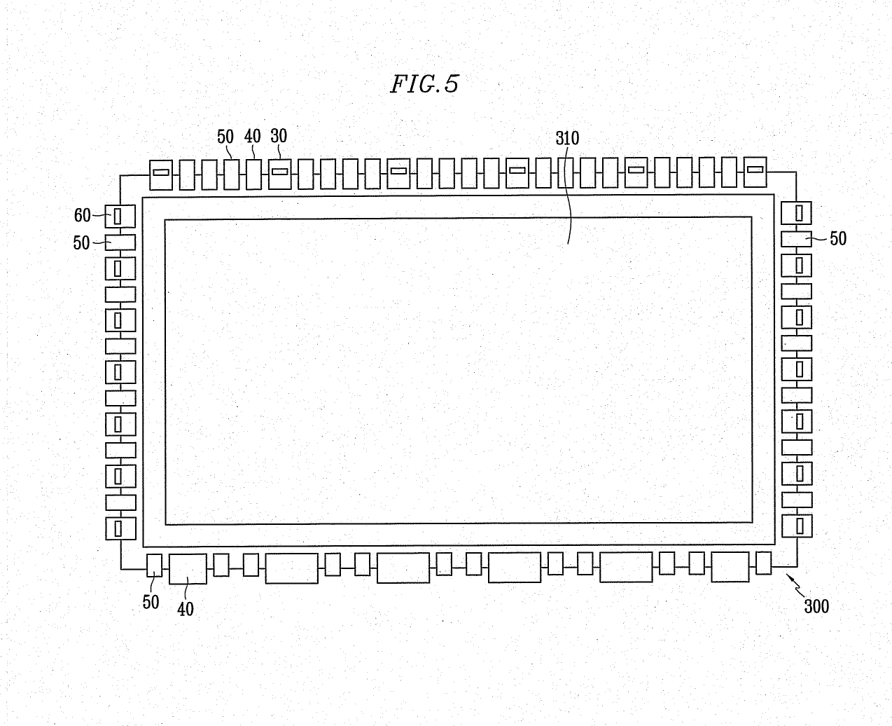

FIG. 5 is a plan view illustrating an exemplary embodiment of an organic light emitting diode display according to the present invention.

Referring to FIG. 5, the exemplary organic light emitting diode display includes an organic light emitting display panel 300. The organic light emitting display panel 300 includes a display region 310 in which a plurality of pixels may be provided and images are substantially displayed. A space (e.g., edge) of a peripheral region other than the display region 310 of the organic light emitting display panel 300 may be a portion where various members for driving the display panel 300 are attached.

A plurality of data driving packages 30 are attached to an upper peripheral region of the organic light emitting display panel 300 and a plurality of scanning driving packages 60 are attached to lateral peripheral regions of the organic light emitting display panel 300. Each of the data driving packages 30 and the scanning driving packages 60 includes a flexible printed circuit film and a driving circuit chip mounted on the flexible printed circuit film. In exemplary embodiments, the data driving packages 30 and the scanning driving packages 60 may be a tape carrier package (“TCP”) type or a chip on film (“COF”) type. However, the present invention is not limited thereto. Alternatively, the circuit may be directly mounted on the display panel 300 or integrated into the display panel 300.

The flexible printed circuits (“FPC”) 40 and 50 are attached among the plurality of data driving packages 30 at the upper peripheral region of the display panel 300, among the plurality of scanning driving packages 60 at lateral peripheral regions of the display panel 300, and in a lower peripheral region of the organic light emitting display panel 300. As illustrated in FIG. 5, the flexible printed circuits 40 and 50 are disposed between a pair of adjacent data driving packages 30, the flexible printed circuits 40 and 50 being alternated. While four alternating flexible printed circuits 40 and 50 are illustrated in FIG. 5 between adjacent data driving packages 30, the invention is not limited thereto. A single flexible printed circuit 40 or 50 is illustrated disposed between a pair of adjacent scanning driving packages 60 on the lateral peripheral portions of the display panel 300, but the invention is not limited thereto. A plurality of the flexible printed circuits 40 and 50, such as being alternated, may be disposed between each pair of adjacent scanning driving packages 60.

In FIG. 5, the data driving packages 30 and/or the scanning driving packages 60 may be attached to another edge of the display panel 300, together with the flexible printed circuits 40 and 50, different from the arrangement of FIG. 5. As illustrated in FIG. 5, the scanning driving packages 60 are attached across substantially entire right and left peripheral regions of the display panel 300, but the data driving packages 30 are attached to only one side of the display panel 300 (e.g., the upper peripheral region) together with the flexible printed circuits 40 and 50. Only the flexible printed circuits 40 and 50 are illustrated attached to the other side of the display panel 300 (e.g., the lower peripheral region). However, the invention is not limited thereto. In an alternative exemplary embodiment, the data driving packages 30 and/or the scanning driving packages 60 may be attached to lateral peripheral portions and the upper peripheral portion, respectively.

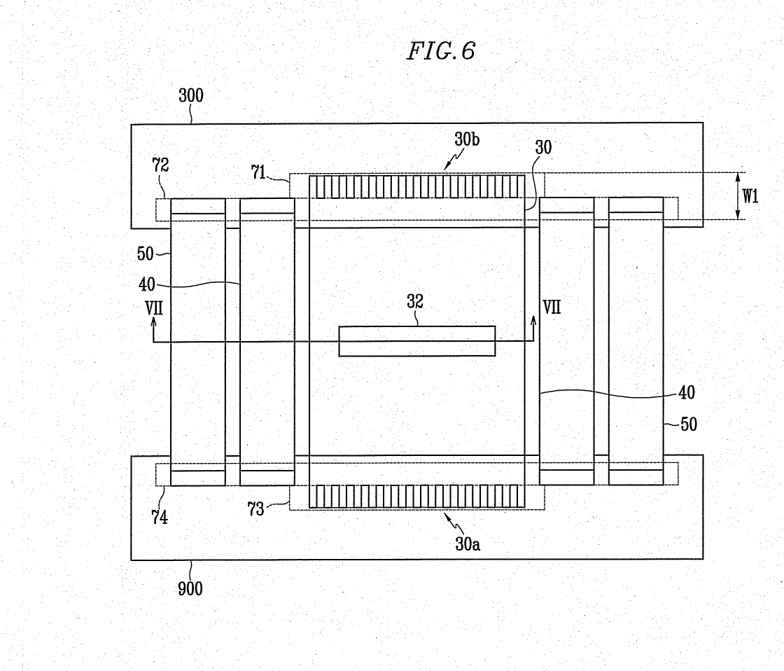

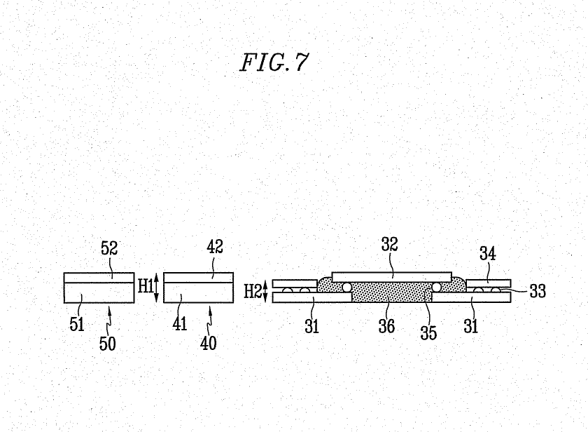

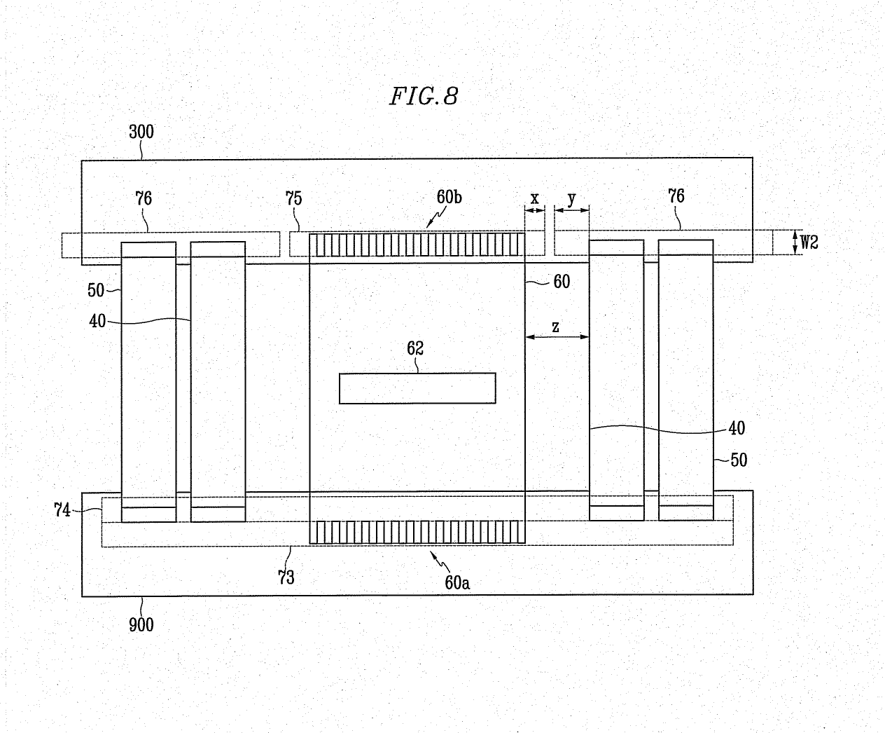

An exemplary embodiment of the organic light emitting diode display according to the present invention will now be described in detail with reference to FIGS. 6 and 7.

FIG. 6 is a plan view illustrating a portion of an exemplary embodiment of the organic light emitting diode display shown in FIG. 5. FIG. 7 is a cross-sectional view of an exemplary embodiment of the organic light emitting diode display shown in FIG. 6 taken along the line VII-VII.

Referring to FIGS. 6 and 7, the driving packages 30 and 60 (See, FIG. 8) and the flexible printed circuits 40 and 50 are attached to the display panel 300 and the printed circuit board 900 to connect the display panel 300 and the printed circuit board 900 to each other. The driving packages 30 and 60 receive image data or various control signals from the printed circuit board 900, and apply a data voltage to the display panel 300. The flexible printed circuits 40 and 50 receive a driving voltage Vdd or a common voltage Vcom from the printed circuit board 900 and transmit the voltage to the display panel 300.

The driving voltage Vdd may be applied to the display panel 300 in a vertical direction and the common voltage Vcom may be applied to the display panel 300 in a vertical direction or a horizontal direction. In one exemplary embodiment, the flexible printed circuit 40 transmitting the driving voltage Vdd and the flexible printed circuit 50 transmitting the common voltage Vcom may be attached to the upper and lower peripheral regions of the organic light emitting display panel 300, and only the flexible printed circuit 50 transmitting the common voltage Vcom may be attached to the lateral peripheral regions of the organic light emitting display panel 300.

The data driving package 30 includes a base film 31, a driving integrated circuit chip 32 mounted on the base film 31 and wiring lines 33 formed on the base film 31.

The base film 31 serves as a supporter of the data driving package 30, maintains a shape of the data driving package 30, and protects the wiring lines 33. The base film 31 has an insulating property or flexibility, and may be formed of a material such as polyimide or the like.

The driving circuit chip 32 may be mounted on a substantially central portion of the base film 31. Resin 36 is filled in the space between the driving circuit chip 32 and the base film 31. The driving circuit chip 32 may be a data driving integrated circuit chip that applies a data voltage to the organic light emitting display panel 300. The driving circuit chip 32 may be a scanning driving integrated circuit chip that applies a scanning voltage to the organic light emitting display panel 300.

The wiring lines 33 are connected to the driving circuit chip 32 through a connection member 35, such as a bump, and are formed toward ends of the driving circuit chip 32 on the base film 31. The wiring line 33 may be made of a metal and may transmit a signal. A passivaion layer 34 is formed on the wiring lines 33. In FIG. 7, the wiring line 33 may be formed on the base film 31, but the present invention is not limited thereto. Alternatively, the wiring line 33 may be below the base film 31.

a first end 30a (hereinafter, referred to as input terminal) of the data driving package 30 is attached to the printed circuit board 900, and a second end 30b (hereinafter, referred to as output terminal) is attached to the organic light emitting display panel 300. The data driving package 30 transmits control signals and driving signals of the various drivers including the scanning driver 400, the data driver 500, and the signal controller 600 that may be mounted on the printed circuit board 900 to the organic light emitting display panel 300.

The flexible printed circuits 40 and 50 include conductive layers 41 and 51 that transmit a common voltage Vcom or a driving voltage Vdd to drive the organic light emitting display panel 300, and the passivation layers 42 and 52 that protect the conductive layers 41 and 51, respectively.

A thickness H1 of the flexible printed circuits 40 and 50 transmitting the common voltage Vcom or the driving voltage Vdd may be larger than a thickness H2 of the driving package 30 that transmits the data voltage or the scanning voltage.

A length from the central portion of the driving package 30, that is, the driving circuit chip 32 to the input terminal 30a, may be greater than the length from central portions of the flexible printed circuits 40 and 50 to the printed circuit board 900 taken in the same direction. The length from the central portion of the driving package 30, that is, the driving circuit chip 32 to the output terminal 30b, may be greater than the length from the central portions of the flexible printed circuits 40 and 50 to the organic light emitting display panel 300 taken in the same direction. That is, the length of the driving package 30 may be greater than the length of the flexible printed circuits 40 and 50 in a direction vertical (e.g., substantially perpendicular to a longitudinal direction of the printed circuit board 900) to the organic light emitting display panel 300 and the printed circuit board 900.

The locations where the driving package 30 and the flexible printed circuits 40 and 50 are attached to the organic light emitting display panel 300 and the flexible printed board 900, respectively, are different from each other. A first region 71 where the driving package 30 is attached to the organic light emitting display panel 300 may be located closer to a central portion (e.g., taken in the vertical direction) of the display panel 300 than a second region 72 where the flexible printed circuits 40 and 50 are attached. A third region 73 where the driving package 30 is attached to the printed circuit board 900 may be located closer to a central portion (e.g., taken in the vertical direction) of the printed circuit board 900 than a fourth region 74 where the flexible printed circuits 40 and 50 are attached.

An exemplary embodiment of a method of manufacturing the organic light emitting diode display will now be described.

Referring to FIGS. 3, 5 and 6, on the insulating substrate 110, the organic light emitting display panel 300 having a display region and a peripheral region are formed. The display region may include a plurality of pixels, each of which includes a switching transistor, a driving transistor, a pixel electrode, and a light emitting element. The peripheral region surrounds the display region.

A first end of the driving package 30 aligns with the peripheral region of the display panel 300. The driving package 30 may be attached to the organic light emitting display panel 300 by a pressure applied by a bonding device (not shown) with an anisotropic conductive film (“ACF”) interposed therebetween. A plurality of driving packages 30 may be individually subjected to aligning or pressing such that a relatively precise process is performed. The anisotropic conductive film may include a resin containing conductive particles so as to electrically connect the driving package 30 and the display panel 300 through the conductive particles.

Respective first ends of each of a plurality of flexible printed circuits 40 and 50 are aligned with the peripheral region of the display panel 300. The ends of the plurality of flexible printed circuits 40 and 50 may be attached to the organic light emitting display panel 300 by applying a pressure with the anisotropic conductive film (“ACF”) interposed therebetween. The plurality of flexible printed circuits 40 and 50 are electrically connected to the display panel 300 through the anisotropic conductive film. The attachment order of the driving package 30 and the plurality of flexible printed circuits 40 and 50 to the display panel 300 may be changed. In exemplary embodiments, either of the driving packages 30 or the plurality of flexible printed circuits 40 and 50 may be attached to the display panel 300 first, or the driving package 30 and the plurality of flexible printed circuits 40 and 50 may be attached substantially simultaneously.

Respective second ends of the flexible printed circuits 40 and 50 are aligned with the printed circuit board 900. The second ends of the flexible printed circuits 40 and 50 may be attached to the printed circuit board 900 by applying a pressure with the anisotropic conductive film interposed therebetween. A second end of the driving package 30 is aligned with the printed circuit board 900, and the driving package 30 may be attached to the printed circuit board 900 by applying a pressure with the anisotropic conductive film interposed between. The attachment order of the driving package 30 and the flexible printed circuits 40 and 50 to the printed circuit board 900 may be changed. In exemplary embodiments, either of the driving packages 30 or the plurality of flexible printed circuits 40 and 50 may be attached to the printed circuit board 900 first, or the driving package 30 and the plurality of flexible printed circuits 40 and 50 may be attached substantially simultaneously.

Since the length of the driving package 30 may be different from that of the flexible printed circuits 40 and 50, attaching of the driving package 30 and the flexible printed circuits 40 and 50 to top (e.g., upper) surfaces of the display panel 300 and the printed circuit board 900 may be separately performed.

In exemplary embodiments, if the driving package 30 and the flexible printed circuits 40 and 50 are simultaneously pressurized, since the thickness of the driving package 30 is different from that of the flexible printed circuits 40 and 50, the pressurizing of one side thereof, such as by the driving package 30, may be incomplete. As in the illustrated embodiments of the present invention, even though the thickness of the driving package 30 may be different from the thickness of the flexible printed circuits 40 and 50, the attaching process may completely be performed on both sides (e.g., at the driving packages 30 and the flexible printed circuits 40 and 50.

Hereinafter, another exemplary embodiment of an organic light emitting diode display according to the present invention will be described in detail with reference to FIG. 8.

Referring to FIG. 8, the organic light emitting diode display includes an organic light emitting display panel 300, a printed circuit board 900, and driving packages 60 and flexible printed circuits 40 and 50 that are attached between the organic light emitting display panel 300 and the printed circuit board 900.

Unlike the exemplary embodiment illustrated in FIG. 6, in the driving package 60 of the display device shown in FIG. 8, a length from the central portion, that is, a driving circuit chip 62 to an output terminal 60b, is substantially equal to that from central portions of the flexible printed circuits 40 and 50 to an input terminal 60a. As such, a region fifth 75 where the driving package 60 is attached to the display panel 300 and a sixth region 76 where the flexible printed circuits 40 and 50 are attached to the display panel 300 may be on a same line (e.g., linearly aligned) taken transverse to longitudinal directions of the driving package 60 and the flexible printed circuits 40 and 50.

The driving package 60 and the flexible printed circuit 40 adjacent to the driving package 60 are attached with a predetermined gap therebetween. Specifically, the distance z between the driving package 60 and the flexible printed circuit 40 adjacent to the driving package 60 satisfies the following equation.

z>x+y (Equation 1)

, Reference character x indicates a length of an edge of the fifth region 75 where a bonding device contacts for attaching the driving package 60 to the top surface of the display panel 300. Character x indicates a length of a portion of the attaching region 75 that does not overlap with the driving package 60 in a direction taken substantially parallel to the top surface of the display panel 300.

Reference character y indicates a length of an edge of the sixth region 76 where a bonding device contacts for attaching the flexible printed circuit 40 to the top surface of the display panel 300. Character y shows a length of a portion of the attaching region 76 that does not overlap the flexible printed circuit 40 in a direction taken substantially parallel to the top surface of the display panel 300.

The driving package 60 and the flexible printed circuit 40 are spaced apart from each other by a predetermined distance, so that the attaching region 75 of the driving package 60 does not overlap the attaching region 76 of the flexible printed circuit 40.

The portions (e.g., lengths) of the driving package 60 and the flexible printed circuit 40 that are attached to the top surface of the printed circuit board 900 are equal to those in the embodiment shown in FIG. 6. A length taken in a direction substantially parallel with the longitudinal direction of the printed circuit board 900 of the attaching region 73 illustrated in FIG. 8 is larger than the attaching region 73 illustrated in FIG. 6. A length of the attaching region 74 is substantially the same in FIGS. 6 and 8.

Hereinafter, an exemplary embodiment of method of manufacturing the organic light emitting diode display in FIG. 8 according to the present invention will be described.

Referring to FIGS. 3, 5 and 8, on the insulating substrate 110, the organic light emitting display panel 300 having a display region and a peripheral region (is formed. The display region includes a plurality of pixels, each of which includes a switching transistor, a driving transistor, a pixel electrode, and a light emitting element. The peripheral region surrounds the display region.

A first end of the driving package 60 is aligned with the peripheral region. The driving package 60 may be attached to the organic light emitting display panel 300 by a pressure applied by a bonding device (not shown) with an anisotropic conductive film (“ACF”) interposed therebetween. First ends of the flexible printed circuits 40 and 50 are aligned with the peripheral region and the first ends the flexible printed circuits 40 and 50 may be attached to the organic light emitting display panel 300 by applying a pressure with the anisotropic conductive film interposed therebetween. The attachment order of the driving package 60 to the flexible printed circuits 40 and 50 to the display panel 300 may be changed. In exemplary embodiments, either of the driving packages 30 or the plurality of flexible printed circuits 40 and 50 may be attached to the display panel first, or the driving package 30 and the plurality of flexible printed circuits 40 and 50 may be attached substantially simultaneously.

The driving package 60 and the flexible printed circuits 40 and 50 are sufficiently spaced apart from each other in a direction substantially parallel to the longitudinal direction of the display panel 300. As a result, even though the distance from the central portion of the driving package 60 (e.g., proximate to the driving circuit chip 62) to the output terminal 60b may be substantially equal to the distance from the central portion of the flexible printed circuits 40 and 50 to the first ends, the process of attaching the driving package 60 and the flexible printed circuits 40 and 50 having the different thickness do not affect each other. Each of the driving package 60 and the flexible printed circuits 40 and 50 may be completely attached to the organic light emitting display panel 300 and a width W2 illustrated in FIG. 8 of the attaching regions 75 and 76 can be smaller than a width W1 illustrated in FIG. 6 of a total width of attaching regions 71 and 72.

Second ends of the flexible printed circuits 40 and 50 are aligned with the printed circuit board 900. The second ends of the flexible printed circuits 40 and 50 may be attached to the printed circuit board 900 by applying a pressure with the anisotropic conductive film interposed therebetween. A second end of the driving package 60 is aligned with the printed circuit board 900 and the driving package 60 may be attached to the printed circuit board 900 by applying a pressure with the anisotropic conductive film interposed therebetween. The attachment order of the driving package 60 to the flexible printed circuits 40 and 50 to the printed circuit board 900 may be changed. In exemplary embodiments, either of the driving packages 30 or the plurality of flexible printed circuits 40 and 50 may be attached to the printed circuit board 900 first, or the driving package 30 and the plurality of flexible printed circuits 40 and 50 may be attached substantially simultaneously.

As in the illustrated exemplary embodiments, completeness (e.g., in a smaller number of steps or sections) of the attaching process can be improved while simplifying the attaching process of the driving package and the flexible printed circuits.

While this invention has been described in connection with what is presently considered to be practical exemplary embodiments, it will be understood that the invention is not limited to the disclosed embodiments thereof. It will be understood by those of ordinary skill in the art that various changes in form and details may be made therein without departing from the spirit and scope of the present invention as defined by the following claims.

What is claimed is:

1. A display device comprising:
a display panel comprising a plurality of pixels;
a printed circuit board driving the display panel;
at least one flexible printed circuit comprising:
an input unit attached to the printed circuit board; and
an output unit attached to the display panel; and
at least one driving package comprising:
an input unit attached to the printed circuit board; and
an output unit attached to the display panel,
wherein a length from a central portion of the at least one driving package to the input unit of the at least one driving package is greater than a length from a central portion of the at least one flexible printed circuit to the input unit of the at least one flexible printed circuit, the lengths from the central portions taken in a longitudinal direction of the flexible printed circuit.

2. The display device of claim 1, wherein a length from the central portion of the at least one driving package to the output unit of the at least one driving package is greater than a length from the central portion of the at least one flexible printed circuit to the output unit of the at least one flexible printed circuit.

3. The display device of claim 1, wherein an attaching region of the output unit of the at least one flexible printed circuit and an attaching region of the output unit of the at least one driving package are formed on a same line in a longitudinal direction of the display panel.

4. The display device of claim 3, wherein a distance Z between the at least one driving package and the at least one flexible printed circuit satisfies a condition Z>X+Y (X indicates a length of an edge of the attaching region of the at least one driving package, and Y indicates a length of an edge of the attaching region of the at least one flexible printed circuit), the distance and the lengths of the edges taken in a transverse direction of the flexible printed circuit.

5. The display device of claim 1, wherein the at least one flexible printed circuit transmits a common voltage.

6. The display device of claim 1, wherein the at least one flexible printed circuit transmits a driving voltage.

7. The display device of claim 1, wherein the at least one driving package comprises a scanning driving integrated circuit.

8. The display device of claim 1, wherein the at least one driving package comprises a data driving integrated circuit.

9. A method of manufacturing a display device, the method comprising:
attaching an output unit of a driving package to a display panel;
attaching an output unit of a flexible printed circuit to the display panel;
attaching an input unit of the driving package to a printed circuit board; and
attaching an input unit of the flexible printed circuit to the printed circuit board,
wherein a length from a central portion of the driving package to the input unit of the driving package is greater than a length from a central portion of the flexible printed circuit to the input unit of the flexible printed circuit, the lengths from the central portions taken in a longitudinal direction of the flexible printed circuit.

10. The method of claim 9, wherein a length from the central portion of the driving package to the output unit of the driving package is greater than a length from the central portion of the flexible printed circuit to the output unit of the flexible printed circuit.

11. The method of claim 9, wherein an attaching region of the output unit of the flexible printed circuit and an attaching region of the output unit of the driving package are on a same line in a longitudinal direction of the display panel.

12. The method of claim 11, wherein a distance Z between the driving package and the flexible printed circuit satisfies a condition Z>X+Y (X indicates a length of an edge of the attaching region of the driving package, and Y indicates a length of an edge of the attaching region of the flexible printed circuit), the distance and the lengths of the edges taken in a transverse direction of the flexible printed circuit.

13. A display device comprising:
a display panel comprising a plurality of pixels;
a printed circuit board driving the display panel;
a flexible printed circuit comprising:
an input unit attached to the printed circuit board; and
an output unit attached to the display panel; and
a driving package comprising:
an input unit attached to the printed circuit board;
and an output unit attached to the display panel,
wherein the input unit of the driving package is located closer to a central portion of the printed circuit board than the input unit of the flexible printed circuit.

14. The display device of claim 13, wherein the output unit of the driving package is located closer to a central portion of the display panel than the output unit of the flexible printed circuit.

15. The display device of claim 13, wherein an attaching region of the output unit of the flexible printed circuit and an attaching region of the output unit of the driving package are on a same line in a longitudinal direction of the display panel.

16. The display device of claim 15, wherein a distance Z between the driving package and the flexible printed circuit satisfies a condition Z>X+Y (X indicates a length of an edge of the attaching region of driving package, and Y indicates a length of an edge of the attaching region of flexible printed circuit), the distance and the lengths of the edges taken in a transverse direction of the flexible printed circuit.
